(19) United States
(12) Patent Application Publication
(10) Pub. No.: US 2003/0014648 A1
(43) Pub. Date: Jan. 16, 2003

(54) Customer authentication system, customer authentication method, and control program for carrying out said method

(75) Inventor: Toshikazu Miyashita, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/190,536

(22) Filed: Jul. 9, 2002

(30) Foreign Application Priority Data
Jul. 10, 2001 (JP) 2001-210024

(51) Int. Cl. H04K 1/00

(52) U.S. Cl. 713/185

(57) ABSTRACT

A customer authentication system that has: body feature information generation means for quantizing a body feature of a customer to generate body feature information; encrypted information generation means for encrypting the body feature information to generate encrypted information; a portable terminal for storing and maintaining the encrypted information; and a customer authentication device for decoding and collating the encrypted information received from the portable terminal and the encrypted information displayed on the portable terminal.

### FIELD OF THE INVENTION

The invention relates to a customer authentication system, a customer authentication method, and a control program for carrying out said method and more particularly to a customer authentication system, a customer authentication method, and a control program for carrying out said method, which are suitable for use in the case, for example, where, after a customer makes a reservation for a ticket through a portable terminal, the customer is authenticated in a reservation center at the time of the handing of the ticket to the customer.

### BACKGROUND OF THE INVENTION

In companies who provide customers, for example, with a reservation reception service for tickets through portable terminals such as portable telephones (cellular phones), at the time of handing of a ticket to a customer, authentication is done, for example, relying upon the number of the credit card of the customer to identify whether or not the customer is the person himself or herself who has reserved the ticket. According to this customer authentication method using the number of the credit card, a person responsible for the sale of tickets inputs the number of the credit card into the terminal to confirm whether or not this number is in agreement with the number which has been registered in the system on the company side. In a service which requires strict security, the authentication of the customer is in some cases carried out by the number of the credit card in combination with a password.

The above conventional customer authentication method, however, suffers from the following problems.

Specifically, in the authentication using the number of credit card, in some cases, the credit card is a forged or stolen credit card, and, thus, in this conventional customer authentication method, there is a limitation on the reliability of confirming whether or not the customer is the person himself or herself who has reserved the ticket. On the other hand, unlike authentication based on body features (for example, fingerprints, handwriting, or voiceprints) of the customer himself or herself, the authentication using the password involves an operation, through which the customer himself or herself inputs the password, that is, is carried out based on the memory of the customer himself or herself. Due to this nature, in general, since the number of characters of the password set is small, the password is often decoded and misappropriated by others. Further, the authentication using the password has another problem that others use a plurality of passwords one of which is identical by chance to the password of the customer. Therefore, in some cases, a mistake occurs in the authentication of the customer, and this disadvantageously makes it impossible to realize a high level of security.

### SUMMARY OF THE INVENTION

Accordingly, it is an object of the invention to provide a customer authentication system, a customer authentication method, and a control program for carrying out the customer authentication method which have a high level of security.

According to the first feature of the invention, a customer authentication system comprises: body feature information generation means for quantizing a body feature of a customer to generate body feature information; encrypted information generation means for encrypting the body feature information to generate encrypted information; a portable terminal for storing and maintaining the encrypted information; and a customer authentication device, wherein the customer authentication device comprises first decoding means for receiving the encrypted information from the portable terminal through a communication line and decoding the encrypted information to generate first decoded information and second decoding means for reading the encrypted information, displayed on a screen of the portable terminal, from the screen and decoding the encrypted information to generate second decoded information, and wherein the customer authentication device collates the first decoded information with the second decoded information and, when the collation result is that the first decoded information is in agreement with the second decoded information, the customer authentication device authenticates the customer as a genuine customer.

According to the second feature of the invention, a customer authentication system comprises: body feature information generation means for quantizing a body feature of a customer to generate body feature information; a portable terminal; and a customer authentication device, wherein the portable terminal comprises encrypted information generation means for permitting the input of the body feature information and encrypting the body feature information to generate encrypted information, first storage means for storing the encrypted information, and display means for displaying the encrypted information on a screen, and wherein the customer authentication device comprises second storage means for receiving and storing the encrypted information through a communication line, reading means for reading an image of the encrypted information displayed on the display means in the portable terminal to generate read information, decoding means for decoding the encrypted information stored in the second storage means to generate first decoded information and, in addition, decoding the read information to generate second decoded information, and collation means which collates the first decoded information with the second decoded information and authenticates the customer as a genuine customer when the collation result is that the first decoded information is in agreement with the second decoded information.

According to the third feature of the invention, a customer authentication system comprises: first body feature information generation means for quantizing a body feature of a customer to generate first body feature information; encrypted information generating means for encrypting the first body feature information to generate encrypted information; second body feature information generation means for quantizing a body feature of the customer to generate second body feature information; and a customer authentication device, wherein the customer authentication device comprises decoding means for receiving the encrypted information from the encrypted information generation means through a communication line and decoding the encrypted information to generate decoded information and collates the second body feature information with the decoded information and authenticates the customer as a genuine customer when the collation result is that the second body feature information is in agreement with the decoded information.

According to the fourth feature of the invention, a customer authentication system comprises: first body feature information generation means for quantizing a body feature of a customer to generate first body feature information; encrypted information generation means for permitting the input of the first body feature information and encrypting the first body feature information to generate encrypted information; second body feature information generation means for quantizing a body feature of the customer to generate second body feature information; and a customer authentication device, wherein the customer authentication device comprises storage means for receiving the encrypted information through a communication line and storing the encrypted information, decoding means for decoding the encrypted information stored in the storage means to generate decoded information, and collation means which collates the second body feature information with the decoded information and authenticates the customer as a genuine customer when the collation result is that the second body feature information is in agreement with the decoded information.

In customer authentication system according to the first, second, third, or fourth feature of the invention, the body feature of the customer may be a fingerprint pattern of any finger of the customer.

According to the fifth feature of the invention, a method for customer authentication comprises the steps of: providing a customer authentication system comprising body feature information generation means, encrypted information generation means, a portable terminal, and a customer authentication device; quantizing a body feature of a customer in the body feature information generation means to generate body feature information; encrypting the body feature information in the encrypted information generation means to generate encrypted information; displaying the encrypted information in the portable terminal on a screen; and receiving the encrypted information in the customer authentication device through a communication line, reading an image of the encrypted information displayed on the portable terminal to generate read information, decoding the read information to generate first decoded information, decoding the received encrypted information to generate second decoded information, collating the first decoded information with the second decoded information, and authenticating the customer as a genuine customer when the collation result is that the first decoded information is in agreement with the second decoded information.

According to the sixth feature of the invention, a method for customer authentication comprises the steps of: providing a customer authentication system comprising body feature information generation means, a portable terminal, and a customer authentication device; inputting a body feature of a customer into the body feature information generation means where the body feature is quantized to generate body feature information (body feature information generation processing); inputting the body feature information into the portable terminal and encrypting the body feature information to generate encrypted information (encrypted information generation processing); storing the encrypted information in the portable terminal (first storage processing); displaying the encrypted information on a screen of the portable terminal (display processing); receiving and storing the encrypted information in the customer authentication device through a communication line (second storage processing); reading an image of the encrypted information, displayed on the display means in the portable terminal, by the customer authentication device to generate read information (reading processing); decoding the encrypted information stored in the second storage processing to generate first decoded information and, in addition, decoding the read information in the customer authentication device to generate second decoded information (decoding processing); and collating the first decoded information with the second decoded information in the customer authentication device, and authenticating the customer as a genuine customer when the collation result is that the first decoded information is in agreement with the second decoded information (collation processing).

According to the seventh feature of the invention, a method for customer authentication comprises the steps of: providing a customer authentication system comprising first body feature information generation means, encrypted information generation means, second body feature information generation means, and a customer authentication device; inputting a body feature of a customer into the first body feature information generation means where the body feature is quantized to generate first body feature information; inputting the first body feature information into the encrypted information generation means where the first body feature information is encrypted to generate encrypted information; inputting a body feature of the customer into the second body feature information generation means where the body feature of the customer is quantized to generate second body feature information; and receiving the encrypted information in the customer authentication device through a communication line, decoding the received encrypted information to generate decoded information, collating the second body feature information with the decoded information, and authenticating the customer as a genuine customer when the collation result is that the second body feature information is in agreement with the decoded information.

According to the eighth feature of the invention, a method for customer authentication comprises the steps of: providing a customer authentication system comprising first body feature information generation means, encrypted information generation means, second body feature information generation means, and a customer authentication device; inputting a body feature of a customer into the first body feature information generation means where the body feature of the customer is quantized to generate first body feature information (first body feature information generation processing); inputting the first body feature information into the encrypted information generation means where the first body feature information is encrypted to generate encrypted information (encrypted information generation processing); inputting a body feature of the customer into the second body feature information generation means where the body feature of the customer is quantized to generate second body feature information (second body feature information generation processing); receiving the encrypted information in the customer authentication device through a communication line and storing the encrypted information in the customer authentication device (storage processing); decoding the encrypted information stored in the storage processing to generate decoded information (decoding processing); and collating the second body feature information with the decoded information and authenticating the customer as a genuine customer when the collation result is that the second body feature information is in agreement with the decoded information (collation processing).

In the method for customer authentication according to the fifth, sixth, seventh or eighth feature of the invention, the body feature of the customer may be a fingerprint pattern of any finger of the customer.

According to a tenth feature of the invention, there is provided a control program for carrying out the method for customer authentication according to the fifth, sixth, seventh or eighth feature of the invention in a computer.

### BRIEF DESCRIPTION OF THE DRAWINGS

The invention will be explained in more detail in conjunction with the appended drawings, wherein:

FIG. 1 is a block diagram showing a customer authentication system in a first preferred embodiment of the invention;

FIG. 2 is a flow chart illustrating the operation of the customer authentication system shown in FIG. 1;

FIG. 3 is a block diagram showing a customer authentication system in a second preferred embodiment of the invention; and

FIG. 4 is a flow chart illustrating the operation of the customer authentication system shown in FIG. 3.

### DESCRIPTION OF THE PREFERRED EMBODIMENTS

Preferred embodiment of the invention will be explained in conjunction with the accompanying drawings.

First Preferred Embodiment

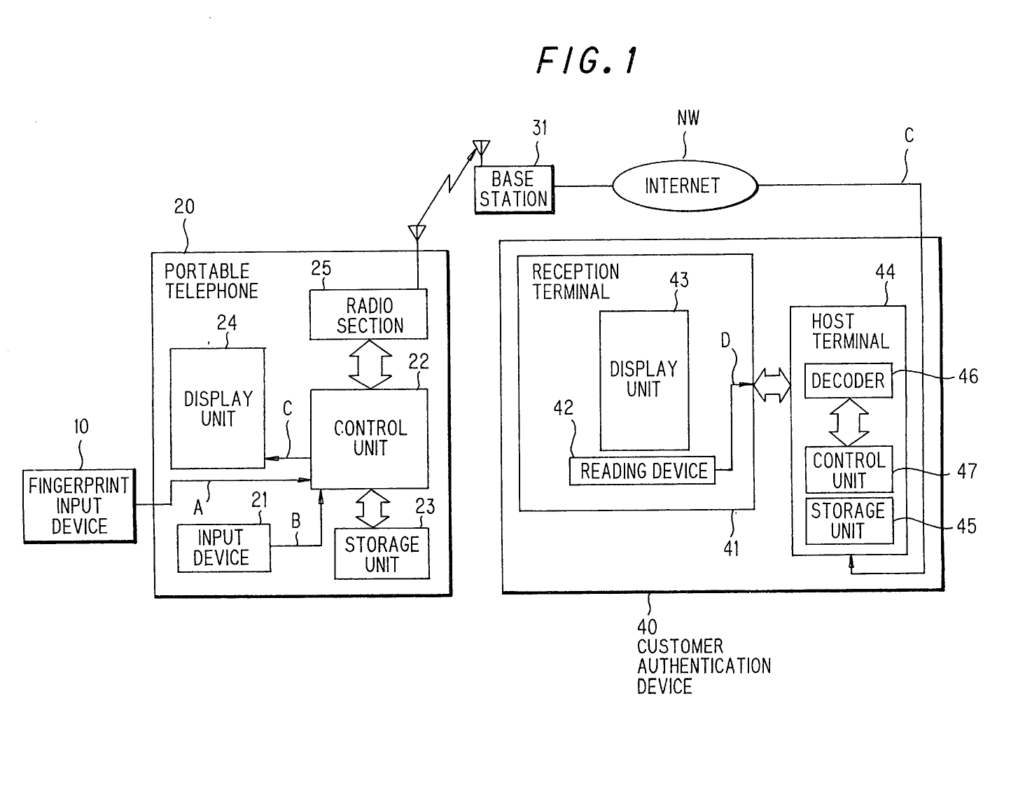

FIG. 1 is a block diagram showing a customer authentication system in the first preferred embodiment of the invention.

As shown in the drawing, the customer authentication system in this preferred embodiment comprises: a fingerprint input device, that is, body feature information generation means, 10; a portable telephone, that is, a portable terminal, 20; a base station 31; the Internet, that is, a communication line, NW; and a customer authentication device 40. The fingerprint input device 10 permits the input of a body feature of a customer, for example, a fingerprint pattern and quantizes the body feature to generate body feature information, for example, fingerprint pattern data, A. The portable telephone 20 comprises: an input device 21; a control unit, that is, encrypted information preparation means, 22; a storage unit, that is, first storage means, 23; a display unit, that is, display means, 24; and a radio section 25.

The input device 21 comprises a plurality of key switches and the like, and reservation information B representing customer number and the contents of the reservation are input into the input device 21 based on the operation of the customer. In the control unit 22, the fingerprint pattern data A is input and encrypted, and the reservation information B is embedded to prepare encrypted information C. In this case, in the encryption, for example, a preset standardized scramble is applied to the fingerprint pattern data A. The storage unit 23 comprises, for example, RAM (random access memory), and stores the encrypted information C. The display unit 24 comprises, for example, LCD (liquid crystal display), and displays the encrypted information C on a screen. The radio section 25 sends the encrypted information C to the base station 31.

The customer authentication device 40 is, for example, an information processing device provided, for example, in a ticket reservation center and comprises: a reception terminal 41; a reading device, that is, reading means, 42 and a display unit 43 which are included in the reception terminal 41; a host terminal 44; a storage unit, that is, second storage means, 45, a decoder, that is, first and second decoding means, 46 which are included in the host terminal 44; and a control unit, that is, collation means, 47. The reading device 42 comprises, for example, an image sensor, and reads an image of the encrypted information C displayed on the display unit 24 of the portable telephone 20 to generate read information D. The display unit 43 displays information for guidance of operation for the customer. The storage unit 45 comprises, for example, RAM, and receives and stores the encrypted information C through the base station 31 and the Internet NW. Further, the storage unit 45 has, recorded thereon, a control program for operating the control unit 47. The decoder 46 decodes the encrypted information C stored in the storage unit 45 to generate first decoded information and, in addition, decodes the read information D to generate second decoded information. This decoding is carried out according to standards corresponding to the standards for the encryption. The control unit 47 controls the whole customer authentication device 40 and collates the first decoded information with the second decoded information. In this case, when the collation result is that the first decoded information is in agreement with the second decoded information, the customer is authenticated as the person which has reserved the ticket.

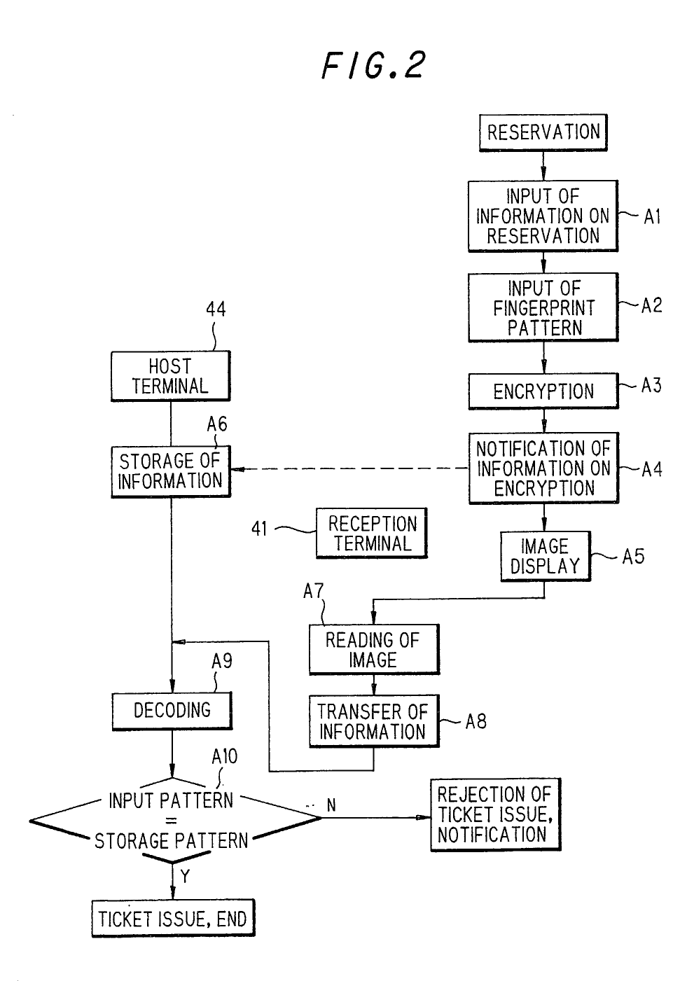

FIG. 2 is a flow chart illustrating the operation of the customer authentication system shown in FIG. 1.

The contents of processing in the method for customer authentication in this embodiment will be explained in conjunction with FIG. 2.

Based on the operation of the customer, reservation information B representing the customer number and the contents of reservation is input through the input device 21 (step A1). A fingerprint pattern of the customer is input into the fingerprint input device 10 and is quantized to generate fingerprint pattern data A (step A2, processing for the generation of body feature information). The fingerprint pattern data A is input into the control unit 22 and is encrypted, and encrypted information C is generated in the control unit 22. The encrypted information C is passed through the radio section 25 and the base station 31 and is sent to the Internet NW (step A3 and step A4, processing for the generation of encrypted information). The encrypted information C is stored in the storage unit 23 (first storage processing) and, in addition, is displayed on the screen of the display unit 24 (step A5, display processing). On the other hand, the encrypted information C is received in the customer authentication device 40 through the Internet NW and is stored in the storage unit 45 (step A6, second storage processing).

When the customer goes to the reservation center and shows the portable telephone 20, the image of the encrypted information C displayed on the display unit 24 of the portable telephone 20 is read by the reading device 42 to generate read information D (step A7, reading processing) which is then transferred to the decoder 46 in the host terminal 44 (step A8). In the decoder 46, the encrypted information C stored in the storage unit 45 is decoded according to the same standards to generate first decoded information, and the read information D is decoded according to standards corresponding to the standards for the encryption to generate second decoded information (step A9, decoding processing). The control unit 47 regards the first decoded information as a stored pattern and the second decoded information as an input pattern and collates the stored pattern with the input pattern. When the collation result is that the stored pattern is in agreement with the input pattern, the customer is authenticated as the person who has reserved the ticket and the ticket is issued to the customer (step A10, collation processing). On the other hand, when the collation result is that the stored pattern is not in agreement with the input pattern, the rejection of issue of the ticket is notified.

Thus, in this first preferred embodiment, the authentication of a customer is carried out using the encrypted information C produced by encrypting the fingerprint pattern data A of the customer. This can specify the customer and, at the same time, can prevent others from posing as the customer and thus can realize the construction of a customer authentication system with a high level of security.

Second Preferred Embodiment

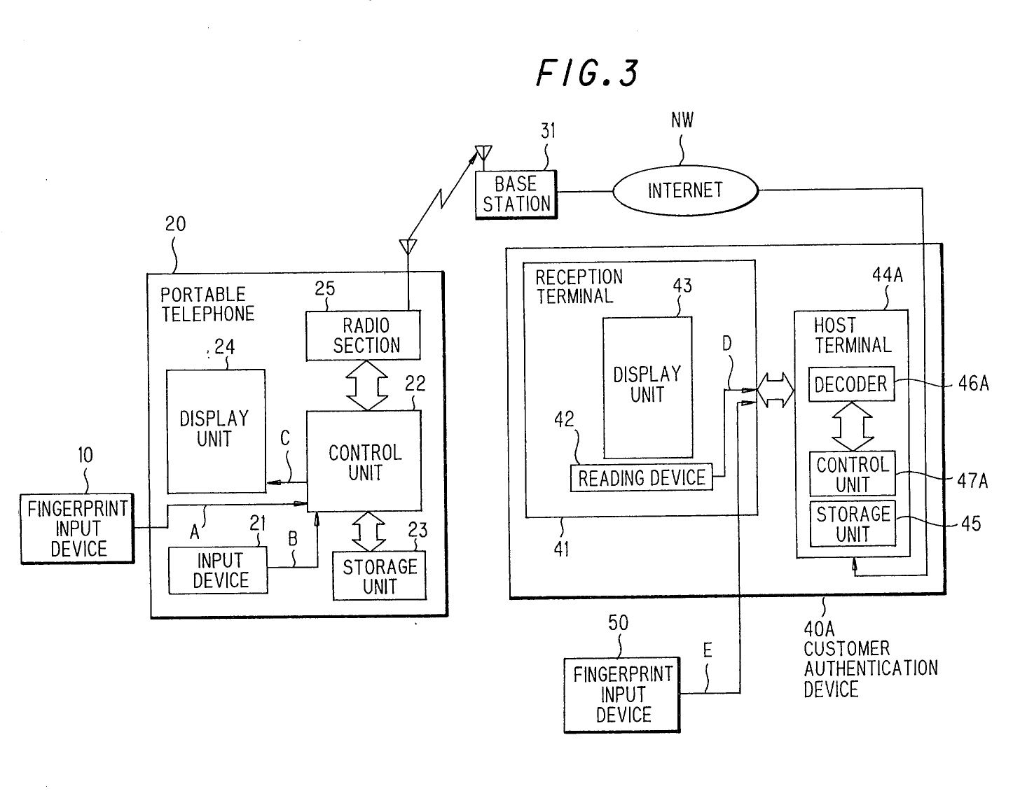

FIG. 3 is a block diagram of a customer authentication system in the second preferred embodiment of the invention. In FIG. 1 (first preferred embodiment) and FIG. 3 (second preferred embodiment), like parts are identified with the same reference characters.

In this customer authentication system, instead of the customer authentication device 40 shown in FIG. 1, a customer authentication device 40A, which is different from the customer authentication device 40 in function, is provided, and, in addition, a fingerprint input device, that is, second body feature information generation means, 50 is provided. In the customer authentication device 40A, instead of the host terminal 44 shown in FIG. 1, a host terminal 44A, which is different from the host terminal 44 in function, is provided. In the host terminal 44A, instead of the decoder 46 and the control unit 47 shown in FIG. 1, a decoder 46A and a control unit 47A, which are different from the decoder 46 and the control unit 47 in function, are provided. In the fingerprint input device 50, the body feature of the customer, for example, fingerprint pattern, is input and quantized to generate body feature information, for example, fingerprint pattern data, E. The decoder 46A decodes the encrypted information C stored in the storage unit 45 to generate decoded information. The control unit 47A collates the fingerprint pattern data E with the decoded information, and when the collation result is that the fingerprint pattern data E is in agreement with the decoded information, the customer is authenticated as the person who has reserved the ticket. The other construction is the same as the construction shown in FIG. 1.

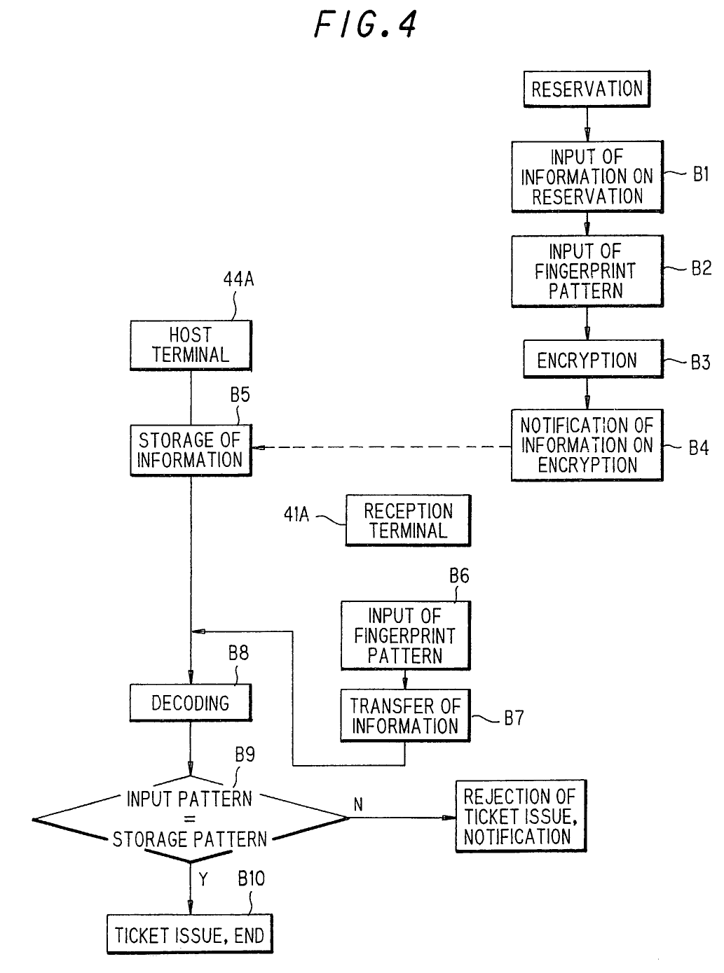

FIG. 4 is a flow chart illustrating the operation of the customer authentication system shown in FIG. 3.

The contents of processing in the method for customer authentication in this embodiment will be explained in conjunction with FIG. 4.

Based on the operation of the customer, reservation information B representing the customer number and the contents of reservation is input through the input device 21 (step B1). A fingerprint pattern of the customer is input into the fingerprint input device 10 and is quantized to generate fingerprint pattern data A (step B2, processing for the generation of first body feature information). The fingerprint pattern data A is input into the control unit 22 and is encrypted, and encrypted information C is generated in the control unit 22. The encrypted information C is passed through the radio section 25 and the base station 31 and is sent to the Internet NW (step B3 and step B4, processing for the generation of encrypted information). On the other hand, the encrypted information C is received in the customer authentication device 40A through the Internet NW and is stored in the storage unit 45 (step B5, storage processing).

When the customer goes to the reservation center, in the fingerprint input device 50, the fingerprint pattern of the customer is input and quantized to generate fingerprint pattern data E (step B6, processing for the generation of second body feature information) which is then transferred to the decoder 46A in the host terminal 44A (step B7). In the decoder 46A, the encrypted information C stored in the storage unit 45 is decoded to generate decoded information (step B8, decoding processing). The control unit 47A regards the fingerprint pattern data E as an input pattern and the decoded information as a storage pattern and collates the input pattern with the stored pattern. When the collation result is that the input pattern is in agreement with the stored pattern, the customer is authenticated as the person who has reserved the ticket and the ticket is issued to the customer (step B9, collation processing). On the other hand, when the collation result is that the input pattern is not in agreement with the stored pattern, the rejection of issue of the ticket is notified.

Thus, in the second preferred embodiment, the fingerprint input device 50 is connected to the customer authentication device 40A. This can eliminate the need for the customer to show the portable telephone 20 at the reservation center, and the input of the fingerprint pattern through the fingerprint input device 50 suffices for the authentication. Therefore, a customer authentication system can be constructed which, in addition to the advantage of the first preferred embodiment, is advantageously simpler in operation and has a higher level of security.

Variants of the above preferred embodiments will be explained. For example, the portable telephone 20 may be a portable terminal having the same function, for example, a personal digital assistant (PDA). Body features of the customer usable herein include, in addition to the fingerprint pattern of any finger of the customer, for example, information representing voiceprint (sound spectrogram), retina pattern, iris, or handwriting. In the first preferred embodiment, the fingerprint pattern data A may be encrypted by other personal computer or the like and input into the control unit 22. In the second preferred embodiment, for example, a personal computer installed in the customer's home or the like may be used instead of the portable telephone 20. Further, the customer authentication devices 40, 40A are not limited to those provided in ticket reservation centers and the like and can be applied to systems, where the authentication of customers is required, in general.

As described above, according to the above construction of the invention, the authentication of a customer is carried out using encrypted information produced by encrypting body feature information of the customer. This can specify the customer and, at the same time, can prevent others from posing as the customer and thus can realize the construction of a customer authentication system with a high level of security. Further, the provision of the second body feature information generation means in the customer authentication device can eliminate the need for the customer to show his or her portable terminal, and the input of the body feature information suffices for the authentication. Therefore, a customer authentication system can be constructed which is simpler in operation and has a higher level of security.

The invention has been described in detail with particular reference to preferred embodiments, but it will be understood that variations and modifications can be effected within the scope of the invention as set forth in the appended claims.

What is claimed is:

1. A customer authentication system, comprising:
body feature information generation means for quantizing a body feature of a customer to generate body feature information;
encrypted information generation means for encrypting the body feature information to generate encrypted information;
a portable terminal for storing and maintaining the encrypted information; and
a customer authentication device, wherein
the customer authentication device comprises
first decoding means for receiving the encrypted information from the portable terminal through a communication line and decoding the encrypted information to generate first decoded information and
second decoding means for reading the encrypted information, displayed on a screen of the portable terminal, from the screen and decoding the encrypted information to generate second decoded information, and wherein
the customer authentication device collates the first decoded information with the second decoded information and, when the collation result is that the first decoded information is in agreement with the second decoded information, the customer authentication device authenticates the customer as a genuine customer.

2. A customer authentication system comprising: body feature information generation means for quantizing a body feature of a customer to generate body feature information; a portable terminal; and a customer authentication device, wherein
the portable terminal comprises
encrypted information generation means for permitting the input of the body feature information and encrypting the body feature information to generate encrypted information,
first storage means for storing the encrypted information, and
display means for displaying the encrypted information on a screen, and wherein
the customer authentication device comprises
second storage means for receiving and storing the encrypted information through a communication line,
reading means for reading an image of the encrypted information displayed on the display means in the portable terminal to generate read information,
decoding means for decoding the encrypted information stored in the second storage means to generate first decoded information and, in addition, decoding the read information to generate second decoded information, and
collation means which collates the first decoded information with the second decoded information and authenticates the customer as a genuine customer when the collation result is that the first decoded information is in agreement with the second decoded information.

3. A customer authentication system comprising: first body feature information generation means for quantizing a body feature of a customer to generate first body feature information; encrypted information generating means for encrypting the first body feature information to generate encrypted information; second body feature information generation means for quantizing a body feature of the customer to generate second body feature information; and a customer authentication device, wherein
the customer authentication device comprises
decoding means for receiving the encrypted information from the encrypted information generation means through a communication line and decoding the encrypted information to generate decoded information and
collates the second body feature information with the decoded information and authenticates the customer as a genuine customer when the collation result is that the second body feature information is in agreement with the decoded information.

4. A customer authentication system comprising:
first body feature information generation means for quantizing a body feature of a customer to generate first body feature information;
encrypted information generation means for permitting the input of the first body feature information and encrypting the first body feature information to generate encrypted information;
second body feature information generation means for quantizing a body feature of the customer to generate second body feature information; and
a customer authentication device, wherein
the customer authentication device comprises
storage means for receiving the encrypted information through a communication line and storing the encrypted information,
decoding means for decoding the encrypted information stored in the storage means to generate decoded information, and
collation means which collates the second body feature information with the decoded information and authenticates the customer as a genuine customer when the collation result is that the second body feature information is in agreement with the decoded information.

5. The customer authentication system according to claim 1, 2, 3, or 4, wherein the body feature of the customer is a fingerprint pattern of any finger of the customer.

6. A method for customer authentication, comprising the steps of:
providing a customer authentication system comprising body feature information generation means, encrypted information generation means, a portable terminal, and a customer authentication device;
quantizing a body feature of a customer in the body feature information generation means to generate body feature information;
encrypting the body feature information in the encrypted information generation means to generate encrypted information;
displaying the encrypted information in the portable terminal on a screen; and
receiving the encrypted information in the customer authentication device through a communication line, reading an image of the encrypted information displayed on the portable terminal to generate read information, decoding the read information to generate first decoded information, decoding the received encrypted information to generate second decoded information, collating the first decoded information with the second decoded information, and authenticating the customer as a genuine customer when the collation result is that the first decoded information is in agreement with the second decoded information.

7. A method for customer authentication, comprising the steps of:
providing a customer authentication system comprising body feature information generation means, a portable terminal, and a customer authentication device;
inputting a body feature of a customer into the body feature information generation means where the body feature is quantized to generate body feature information (body feature information generation processing);
inputting the body feature information into the portable terminal and encrypting the body feature information to generate encrypted information (encrypted information generation processing);
storing the encrypted information in the portable terminal (first storage processing);
displaying the encrypted information on a screen of the portable terminal (display processing);
receiving and storing the encrypted information in the customer authentication device through a communication line (second storage processing);
reading an image of the encrypted information, displayed on the display means in the portable terminal, by the customer authentication device to generate read information (reading processing);
decoding the encrypted information stored in the second storage processing to generate first decoded information and, in addition, decoding the read information in the customer authentication device to generate second decoded information (decoding processing); and
collating the first decoded information with the second decoded information in the customer authentication device, and authenticating the customer as a genuine customer when the collation result is that the first decoded information is in agreement with the second decoded information (collation processing).

8. A method for customer authentication, comprising the steps of:
providing a customer authentication system comprising first body feature information generation means, encrypted information generation means, second body feature information generation means, and a customer authentication device;
inputting a body feature of a customer into the first body feature information generation means where the body feature is quantized to generate first body feature information;
inputting the first body feature information into the encrypted information generation means where the first body feature information is encrypted to generate encrypted information;
inputting a body feature of the customer into the second body feature information generation means where the body feature of the customer is quantized to generate second body feature information; and
receiving the encrypted information in the customer authentication device through a communication line, decoding the received encrypted information to generate decoded information, collating the second body feature information with the decoded information, and authenticating the customer as a genuine customer when the collation result is that the second body feature information is in agreement with the decoded information.

9. A method for customer authentication, comprising the steps of:
providing a customer authentication system comprising first body feature information generation means, encrypted information generation means, second body feature information generation means, and a customer authentication device;
inputting a body feature of a customer into the first body feature information generation means where the body feature of the customer is quantized to generate first body feature information (first body feature information generation processing);
inputting the first body feature information into the encrypted information generation means where the first body feature information is encrypted to generate encrypted information (encrypted information generation processing);
inputting a body feature of the customer into the second body feature information generation means where the body feature of the customer is quantized to generate second body feature information (second body feature information generation processing);
receiving the encrypted information in the customer authentication device through a communication line and storing the encrypted information in the customer authentication device (storage processing);
decoding the encrypted information stored in the storage processing to generate decoded information (decoding processing); and
collating the second body feature information with the decoded information and authenticating the customer as a genuine customer when the collation result is that the second body feature information is in agreement with the decoded information (collation processing).

10. The method for customer authentication according to claim 6, 7, 8, or 9, wherein the body feature of the customer is
a fingerprint pattern of any finger of the customer.

11. A control program for carrying out the method for customer authentication according to claim 6, 7, 8, or 9 in a computer.
